(19) United States
(12) Patent Application Publication
(10) Pub. No.: US 2010/0223071 A1
(43) Pub. Date: Sep. 2, 2010

(54) SYSTEMS, METHODS, APPARATUSES, AND COMPUTER PROGRAM PRODUCTS FOR ORGANIZING PATIENT INFORMATION

(75) Inventors: Michele Kland, Boulder, CO (US); Eric Rivedal, Denver, CO (US); Judy Richmeier-Harney, Louisville, CO (US); Karl Wolf, Boulder, CO (US); Terri Barylak-Roge, Littleton, CO (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/396,079

(22) Filed: Mar. 2, 2009

(51) Int. Cl. G06Q 50/00; G06Q 99/00; G06F 15/16; G08B 23/00

(52) U.S. Cl. 705/3; 705/2; 705/9; 709/219; 340/573.1

(57) ABSTRACT

An apparatus and system are provided for facilitating organization of medical data, associated with a patient(s) to enable medical professionals to prioritize and deliver timely and appropriate care to one or more patients. The apparatus includes a processor configured to receive medical information, associated with a patient(s), from one or more entities and store the medical information in a memory. The processor is also configured to provide a portion(s) of the medical information to a view of a display(s) and update a portion of the medical information upon receiving new medical data associated with the portion in response to determining that the new medical data corresponds to the patient(s). The processor is also configured to provide the portion of the medical information to a view of a display(s).

### TECHNOLOGICAL FIELD

Embodiments of the invention relate generally to systems, methods, apparatuses and computer program products for providing an efficient mechanism for enabling medical care personnel to manage, prioritize and organize patient care so that medical information associated with one or more patients may be accessible from a single graphical user interface and so that medical care personnel may receive current information regarding one or more patients medical status.

### BACKGROUND

Delivering medical care is increasingly becoming complex and staying apprised of a patient's medical status is oftentimes difficult. Today, medical personnel (e.g., clinicians) may rely on a variety of methods to stay apprised of their patients' condition. For instance, currently, in order to access medical information associated with a patient, medical personnel typically search for the relevant patient information within a variety of hospital information systems, all of which may have separate log-ons, user interfaces, and functionality. For instance, today, vital medical data associated with one or more patients may be maintained in a pharmacy system, a laboratory system, an ADT system, an Order Entry system, or the like and information pertaining to the patient(s) is typically separately retrieved from each of these hospital information systems in order for medical personnel to utilize the data or other information in providing care for the patient(s). In this regard, a patient care plan may be separate from one or more physician orders as well as other pertinent medical information associated with one or more patients and as such medical personnel (e.g., nurses) typically need to look in different places to get a complete understanding of what medical care is needed for each patient.

For instance, medical personnel may rely on paper documentation, one or more nursing care plans or summaries regarding patient information (e.g., a Kardex™ system), electrical apparatuses (e.g., mobile telephones, pagers, etc.), notes that they keep in their pockets, their memories and a variety of other sources to stay up to date and current regarding a patient's medical status. However, failure to make all pertinent medical information, associated with a patient, available or accessible from a single source may create opportunities for errors to occur and may ultimately result in critical changes in a patient's medical condition going unnoticed and untreated. For instance, if a clinician such as a nurse, for example, forgets to check for a laboratory result associated with a patient, critical values may not be timely addressed, potentially resulting in additional deterioration in the patient's health. Additionally, if a medical clinician such as for example a nurse loses a paper reminder to assess a patient's pain status after administering a narcotic, the consequence of such a loss may result in the patient experiencing unnecessary pain and the facility not meeting Joint Commission requirements.

It should also be pointed out that “The Joint Commission”, which accredits and certifies more than 15,000 health care organizations and programs in the United States, is beginning to require health care institutions to utilize an interdisciplinary medical plan of care for a patient(s) that is accessible from a single source, so that all pertinent medical information associated with a plan of care for a patient is accessible from one source.

Thus, a need exists to provide a more efficient mechanism of gathering or retrieving medical information, associated with one or more patients, which originated from one or more distinct sources, such as different medical institutions or medical systems, and make this information available for medical personnel to access from a single source as well as a manner in which to enable this medical information associated with one or more patients to be accessible via a common display.

### BRIEF SUMMARY

One or more exemplary embodiments may improve efficiency of delivering medical care in a medical institution by eliminating the need for medical personnel such as for example a nurse(s) to utilize multiple sources of patient information such as a paper Kardex™ system, notes, documentation and the like as well as the need to search multiple medical institutions, for example multiple hospital information systems, for new patient orders, laboratory results, medical charts, interventions, care plans as well as other pertinent medical information. In this regard, the exemplary embodiments may automatically update patient information in a single source that is maintained by disparate medical systems which may eliminate a need for medical personnel to search multiple sources for medical data associated with one or more patients.

The exemplary embodiments may simplify access to patient information by providing a summary view of patient data in a single view. The patient data may include, but is not limited to, an interdisciplinary plan of care and may serve as a mechanism to access other medical systems that may be maintained by medical institutions. The exemplary embodiments enable critical information to be seen quickly and efficiently with automatic updates displaying new results, orders and alerts relating to one or more patients.

Additionally, the exemplary embodiments may increase the efficiency of delivering care by eliminating numerous steps to gather patient information from different medical systems and may create electronic reminders that may alert medical personnel that critical events need to take place regarding the provision of patient care. For example, the exemplary embodiments may generate one or more reminders to perform pain assessments and other tasks to eliminate medical personnel's need to rely on memory or paper-based notes, for example. The exemplary embodiments may also be utilized to facilitate viewing of up-to-date information that can be personalized to meet the individual needs of a medical staff member throughout a work shift.

The exemplary embodiments may display patient information from disparate medical systems in a single view of a display and thus allow medical personnel such as clinicians for example to organize and prioritize patient care. For instance, the exemplary embodiments may be integrated with one or more medical systems and retrieve medical information from these medical systems which may be utilized to display a complete interdisciplinary care plan in one view enabling clinicians to see what medical care needs to be performed for one or more patients.

The exemplary embodiments may show a summary of patient data associated with one or more patients, including but not limited to, current charting information, results (e.g., lab results), orders (e.g., prescriptions from a pharmacy) and any other suitable medical information. Additionally, one or more data views of a display may be configurable by discipline and by type of clinician. For example, the exemplary embodiments may be configured differently for an intensive care unit (ICU) nurse as opposed to a respiratory therapist. Also, data may be sorted and filtered by medical personnel as needed. For instance, clinicians may quickly filter data to only show overdue medications, new laboratory results or any other suitable information. Users of the exemplary embodiments may also set preferences for viewing data to meet their specific workflow needs at any time during a work shift. The exemplary embodiments may enable multiple patients across multiple medical units of a medical institution to be viewed on a display as well as a single patient within a medical unit of a medical institution.

Exemplary embodiments may facilitate retrieval of new laboratory results, orders, critical intravenous infusions, medications, documentation, alerts, care plans and any other suitable data and may display information logically providing clinicians a broad view of one or more patient's status. Additionally, the exemplary embodiments may provide a graphical user interface such as for example a display showing one or more icons and alerts that may allow medical personnel to quickly prioritize patient care and determine patients having critical patient care needs.

Moreover, the exemplary embodiments may provide a mechanism that provides single click access to more detailed information associated with medical data pertaining to a patient(s) such as for example access to one or more administrations, orders, alerts and other suitable medical information. In this regard, the exemplary embodiments can chart, verify new orders, update tasks and alerts and may complete or finalize required documentation and orders as well as create one or more reminders reminding clinicians that critical events associated with the medical care of a patient(s) need to be performed.

The exemplary embodiments may simplify accesses to patient information by providing a summary view of patient data on a single display view which may include information associated with an interdisciplinary plan of care and may access other systems. Critical information associated with one or more patients may be shown on the display quickly and efficiently and may automatically display information associated with new medical results, orders and alerts and any other suitable information corresponding to one or more patients.

The exemplary embodiments of the invention improves workflow efficiency by eliminating the need for nurses to use a paper Kardex™ system, notes, and the need to look in numerous systems for new patient orders, laboratory results, charting, interventions, and the care plan. Failing to display all pertinent patient information in a single view may create opportunities for errors and timely recognition of critical changes in a patient's condition.

In one exemplary embodiment a corresponding method and computer program product for facilitating organization of medical data, associated with one or more patients, in a single view of one or more displays are provided. The method and computer program product may include receiving medical information from one or more different computer systems and storing the received medical information in a memory. The received medical information may be associated with one or more patients. Additionally, the method and computer program product may include examining received medical information stored in the memory and identifying whether data in the received medical information indicates that the medical information corresponds to one or more patients. The data includes one or more unique identifiers (IDs) associated with the patients. The method and computer program product also may include providing one or more portions of the received medical information to a single view of one or more displays and configuring the portions of the received medical information to generate a summary view of the received medical information. The medical information is associated with at least one of the patients. The method and computer program product may also include updating a first portion of the received medical information upon receiving additional medical data associated with the first portion in response to a determination indicating that the additional medical data corresponds to a patient. The additional medical data is also being stored in the memory. The method and computer program product also may include providing the first portion of the received medical data, as updated, to a single view of the one or more displays and providing an alert(s), received from at least one of the different computer systems, to the summary view. The alert(s) includes data indicating a medical status of a patient.

In yet another exemplary embodiment, an apparatus is provided for facilitating organization of medical data, associated with one or more patients, in a single view of one or more displays. The apparatus may include a processor configured to receive medical information from one or more different computer systems. The received medical information may be associated with one or more patients. The processor is also configured to store the received medical information in a memory and examine the received medical information stored in the memory and identify whether data in the received medical information indicates the medical information corresponds to one or more patients. The data comprises one or more unique identifiers (IDs) associated with the one or more patients. The processor is further configured to provide one or more portions of the received medical information to a single view of one or more displays and manipulate the portions of the received medical information to generate a summary view of the medical information. The medical information is associated with at least one of the patients. The processor is also configured to update at least a first portion of the received medical information upon receiving additional medical data associated with the first portion in response to a determination indicating that the additional medical data corresponds to a patient. The additional medical data is stored in the memory. Additionally, the processor is configured to provide the first portion of the received medical information, as updated, to a single view of the one or more displays and provide an alert(s), received from at least one of the different computer systems, to the summary view, the alert(s) includes data indicating a medical status associated with the patient.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of an electronic device according to an exemplary embodiment of the invention;

FIG. 2 is a schematic block diagram of a system for organizing medical information associated with one or more patients according to an exemplary embodiment of the invention;

FIG. 3 is a schematic block diagram of a system according to an exemplary embodiment of the invention;

FIG. 4 illustrates medical information associated with one or more patients in a medical unit of a medical institution that is provided to a display by a processor of a server according to an exemplary embodiment of the invention;

FIG. 5 illustrates a view of a healthcare professional's assigned patients and one or more action items that the health care professional is scheduled to perform at specified times for one or more patients according to an exemplary embodiment of the invention;

FIG. 6 illustrates a display showing medical information associated with a patient in a medical unit of a medical institution according to an exemplary embodiment of the invention;

FIG. 7 illustrates a summary of medical information associated with a patient according to an exemplary embodiment of the invention;

FIG. 8 illustrates a flowchart for facilitating organization of medical data, associated with one or more patients, in a single view of a display(s) according to an exemplary embodiment of the invention;

FIG. 9 illustrates a view of a Kardex panel configured to allow free-text entry according to an exemplary embodiment of the invention;

FIG. 10 illustrates a task creation management view according to an exemplary embodiment of the invention;

FIG. 11 illustrates a modify and complete task view which includes field narratives according to an exemplary embodiment of the invention;

FIG. 12 illustrates a patient self-assignment view according to an exemplary embodiment of the invention;

FIG. 13 illustrates a patient data monitor view configurable to show one or more patients according to an exemplary embodiment of the invention;

FIG. 14 illustrates a charge nurse view according to an exemplary embodiment of the invention;

FIG. 15 illustrates a care coordinator view according to an exemplary embodiment of the invention;

FIG. 16 illustrates a smart communication view according to an exemplary embodiment of the invention;

FIG. 17 illustrates a schedule management view according to an exemplary embodiment of the invention;

FIG. 18 illustrates a view of a clinician's organizational report according to an exemplary embodiment of the invention; and

FIG. 19 illustrates a view of a patient's itinerary report according to an exemplary embodiment of the invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. Moreover, the term “exemplary”, as used herein, is not provided to convey any qualitative assessment, but instead merely to convey an illustration of an example.

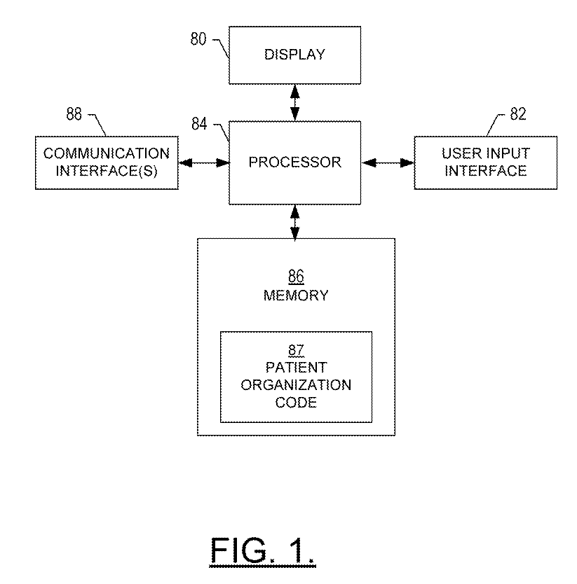

FIG. 1 illustrates a block diagram of an electronic device such as a client, server, computing device (e.g., personal computer (PC), computer workstation, laptop computer, personal digital assistant, etc.) or the like that would benefit from embodiments of the invention. The electronic device includes various means for performing one or more functions in accordance with exemplary embodiments of the invention, including those more particularly shown and described herein. It should be understood, however, that one or more of the electronic devices may include alternative means for performing one or more like functions, without departing from the spirit and scope of the invention. More particularly, for example, as shown in FIG. 1, the electronic device can include a processor 84 connected to a memory 86. The memory can comprise volatile and/or non-volatile memory, and typically stores content, data or the like. For example, the memory may store content transmitted from, and/or received by, the electronic device. The memory is capable of storing data including but not limited to medical data such as medical diagnoses, laboratory results, medical measurements, medical chart data, patient prescriptions, alerts, patient care plans, one or more orders (e.g., an order(s) by a health care professional (e.g., a doctor) to give a patient a prescribed drug (e.g., Ancef) every eight hours, or to reposition a patient every two hours, etc.), patient summary information or any other suitable medical data associated with one or more patients. The one or more orders may consist of data, content, information or the like related to instructions provided to medical personnel for administering medical care to one or more patient(s).

Also for example, the memory typically may store one or more client applications, instructions or the like that is executed by the processor 84 to perform steps associated with the operation of the electronic device in accordance with embodiments of the present invention. As explained below, for example, the memory may store one or more client application(s), for instance, software, such as for example a patient organization algorithm 87, which may retrieve patient information from disparate medical systems or different computer systems and automatically arrange this information in a single view of a display allowing medical personnel to organize and prioritize patient care. In this regard, the patient organization algorithm, upon being executed by the processor 84, may generate an interdisciplinary patient care plan which may be visible in a single view of a display and which may enable medical personnel to determine medical care that needs to be provided to the patient.

The electronic device can include one or more logic elements for performing various functions of one or more client application(s). The logic elements performing the functions of one or more client applications may be embodied in an integrated circuit assembly including one or more integrated circuits integral or otherwise in communication with a respective network entity (e.g., computing system, client, server, etc.) or more particularly, for example, a processor 84 of the respective network entity.

In addition to the memory 86, the processor 84 can also be connected to at least one interface or other means for displaying, transmitting and/or receiving data, content or the like. The interface(s) can include at least one communication interface 88 or other means for transmitting and/or receiving data, content or the like. In this regard, the communication interface 88 may include, for example, an antenna and supporting hardware and/or software for enabling communications with a wireless communication network. For example, the communication interface(s) can include a first communication interface for connecting to a first network, and a second communication interface for connecting to a second network. In this regard, the electronic device is capable of communicating with other electronic devices over a network such as a Local Area Network (LAN), Wide Area Network (WAN), Wireless Wide Area Network (WWAN), the Internet, or the like. Alternatively, the communication interface may support a wired connection with the respective network. In addition to the communication interface(s), the interface(s) may also include at least one user interface that may include one or more earphones and/or speakers, a display 80, and/or a user input interface 82. The display 80 is capable of displaying information including but not limited to medical data associated with one or more patients. In this regard, the display is capable of showing medical information associated with one or more patients, which may be retrieved from one or more disparate medical or facilities, for example hospital information systems, and may show this information in a single view of the display and the information visible on the display may be accessible by medical personnel to organize and prioritize patient care. Additionally, the display is capable of showing one or more medical orders, laboratory results, patient summary information, medical charting information, the location of patients in a medical unit, one or more alerts, interdisciplinary care plans, prescription information and any other suitable medical information including but not limited to web pages associated with one or more websites. The user input interface, in turn, can comprise any of a number of devices allowing the entity to receive data from a user, such as a microphone, a keypad, keyboard, a touch display, a joystick, image capture device, pointing device (e.g., mouse), stylus or other input device.

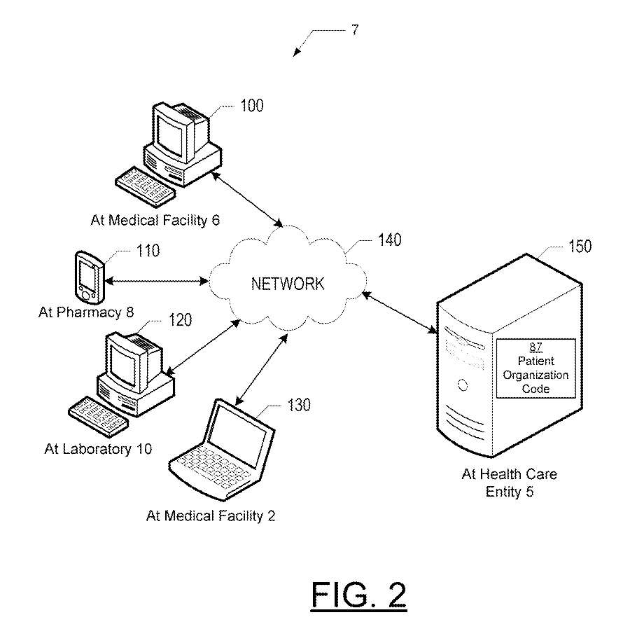

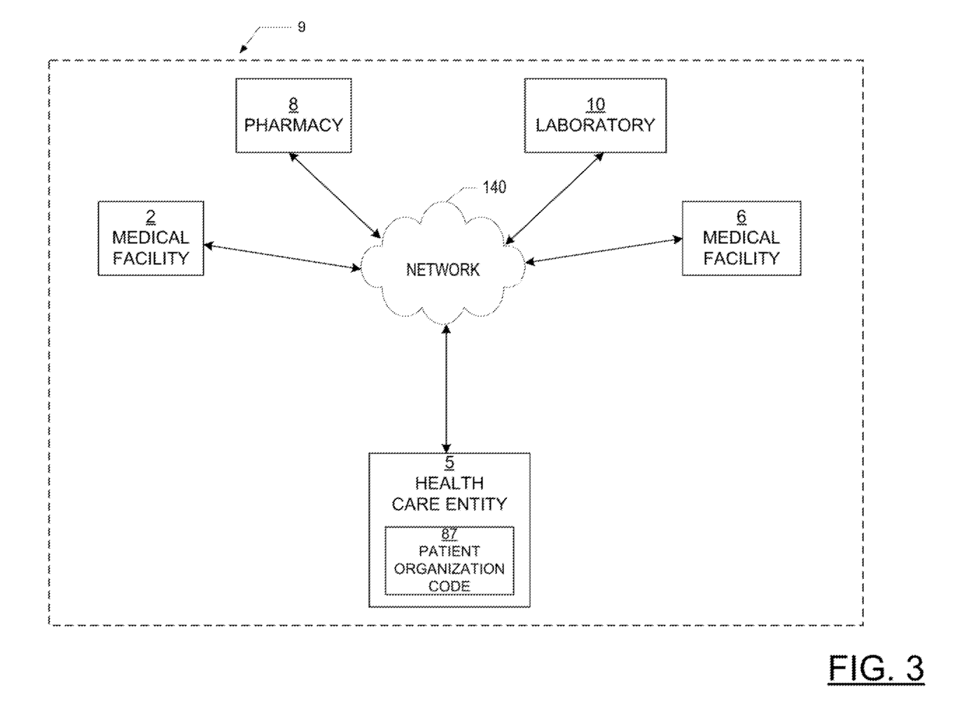

Reference is now made to FIG. 2, which is a block diagram of an overall system that would benefit from exemplary embodiments of the invention. It should be pointed out that one or more of the components of FIG. 2 may comprise the elements of the electronic device illustrated in FIG. 1. As shown, the system 7 may include one or more electronic devices 100, 110, 120, 130 (e.g., personal computers, laptops, personal digital assistants and the like) which may be operated by medical personnel, including but not limited to nurses, therapists, physicians, pharmacists and any other suitable health care professionals in order to access a server 150, or similar network entity, over a network 140, such as a wired or wireless local area network (LAN), a metropolitan network (MAN) and/or a wide area network (WAN) (e.g., the Internet). The electronic devices 100, 110, 120 and 130 as well as the server 150 may be maintained by one or more health care institutions. For instance, the electronic device 100 may be maintained by a medical facility 6 (also referred to herein as the medical unit, the electronic device 110 may be maintained by a pharmacy (also referred to herein as a pharmacy information system (PIS)), the electronic device 120 may be maintained by a laboratory (also referred to herein as a laboratory information system (LIS)), and the electronic device 130 may be maintained by a medical facility 2 (also referred to herein as a computerized order entry system). (See also e.g., FIG. 3) Additionally, the server 150 may be maintained by a health care institution 5 (also referred to herein as a health care entity). (See also e.g., FIG. 3) While four electronic devices 100, 110, 120 and 130 are shown in FIG. 2, it should be pointed out that any suitable number of electronic devices may be part of the system of FIG. 2. In addition, although there is one server 150 shown in FIG. 2 it should be pointed out that any suitable number of servers may be part of the system of FIG. 2. Moreover, while a server is mentioned for purposes of illustration, its functions could be performed by many other types of computing devices. In an exemplary embodiment, medical information associated with a patient(s) that is generated by the patient organization algorithm may be viewed on any of the displays of the electronic devices 100, 110, 120 and 130 while the patient organization algorithm 87 resides on the server 150.

The processor (e.g., processor 84) of the server 150 may execute one or more algorithms or software stored in a memory. For example, the processor of the server 150 may execute software, such as for example the patient organization algorithm 87 (also referred to herein as the organize my day algorithm). In response to the processor executing the patient organization algorithm 87, the processor may retrieve medical data, associated with one or more patients, from one or more disparate entities such as for example medical facility 6, pharmacy 8, laboratory 10, medical facility 2 or any other suitable medical entities. The medical data that may be retrieved by the processor of the server 150 may include, but is not limited to, laboratory results, measurements, medical chart information, one or more medical diagnoses, prescription data, a primary language of a patient(s), information associated with an attending physician, data associated with one or more patient's diet, order(s) information, one or more patient care plans, alert data, patient admission date/time, emergency contact information, information associated with a location of one or more patients within a medical unit of a health care facility, status information associated with one or more tasks (e.g., a status of overdue in response to a task not being performed by an assigned time or upon the expiration of a time) and any other suitable medical data. It should be pointed out that the medical data described in the foregoing sentence may be referred to herein interchangeably as medical information. The medical chart information may be any medical information that is arranged for display in a chart so that it can be easily identified and analyzed. As described above, an order(s) may contain data, content, information or the like related to one or more instructions provided to medical personnel for administering medical care to one or more patient(s). The alerts may consist of reminders or other messages informing medical care personnel, assigned to care for one or more patients, of critical events. For instance, the processor of the server 150 may generate an alert(s) that may be sent to a health care professional(s) in the form of a message before a critical event (e.g., perform a pain assessment 20 minutes after giving a narcotic analgesic to a patient) takes place to remind the health care professional(s) to provide medical care at the specified time (e.g., 20 minutes after administering a narcotic analgesic).

It should be pointed out that the processor of the electronic device 130 of medical facility 2 and the processor of the electronic device 100 of medical facility 6 may both execute one or more order entry applications, which may be utilized by a health care professional (e.g., physician) to generate instructions that may be sent to medical personnel. The instructions may indicate a specific manner in which to provide medical care to one or more patients. For example, a health care professional may utilize a keyboard, for example, of a user input interface to generate an instruction that instructs a nurse to reposition a patient on bed rest every three hours or administer a specified dosage of a drug to a patient at a specified time of day or any other suitable instructions.

The medical information associated with one or more patients may be retrieved by the processor of the server from one or more medical entities (e.g., medical facility 2, laboratory 10, pharmacy 8, and medical facility 6) based on a unique identifier (ID) associated with a patient(s). The unique ID may consist of an alphanumeric code that is used to identify a patient. As an example, consider a patient named Wanda Jameson that is assigned a unique ID such as for example “33 77 12 C”. In response to the pharmacy 8, for example, generating a new prescription for Wanda Jameson, medical data associated with this prescription may include the unique ID (e.g., 33 77 12 C) associated with the patient Wanda Jameson and may be sent by the processor of the electronic device 110, maintained by the pharmacy 8, to the server 150. The data received by the server 150 from the electronic device 110 (as well as medical data received from electronic devices 100, 120 and 130) may be stored in a memory (e.g., memory 86) of the server 150. In this regard, the processor of the server 150 may examine data stored in its memory and determine that new medical data, associated with a prescription in this example, has been received corresponding to patient Wanda Jameson and may send this medical data to a display such as display 80 so that the medical data can be seen by medical personnel and utilized in order to provide medical care to patient Wanda Jameson. The prescription data sent to a display by the processor of the server may be displayed along with other medical data associated with a patient, such as for example, Wanda Jameson. The processor of the server 150 may determine that new medical information associated with a patient was received by examining data containing the unique ID associated with the patient, which in this example is 33 77 12 C.

As another example, laboratory results (also referred to herein as lab results and lab) associated with patient Wanda Jameson may include data identifying the unique ID assigned to patient Wanda Jameson and may be sent by the processor of the electronic device 120, maintained by laboratory 120, to the server 150. The processor of the server 150 may store these laboratory results in its memory and the processor of the server 150 may analyze the data associated with these laboratory results and may detect the unique ID (e.g., 33 77 12 C) corresponding to patient Wanda Jameson. In this regard, the processor of the server 150 may send the laboratory results corresponding to patient Wanda Jameson to one or more displays so that the laboratory results may be viewed by medical personnel. It should be pointed out that the laboratory results sent to a display by the processor of the server may be displayed along with other medical data associated with a patient, in this example Wanda Jameson. In the above example, it should be pointed out that patient Wanda Jameson is a fictitious person for purposes of illustration.

Referring now to FIG. 3, a system in which devices of FIG. 2 that are maintained and operated by entities such as medical facility 2, laboratory 10, pharmacy 8, medical facility 6 and health care institution 5 may be coupled to each other via network 140. The system 9 of FIG. 3 may be maintained and operated by a single entity. Alternatively, the system 9 of FIG. 3 may be maintained and operated by one or more entities. The health care entity 5 may contain a device (e.g., the processor of server 150) that executes the patient organization algorithm 87, which may receive or retrieve medical data associated with one or more patients that may be stored and maintained at disparate medical entities, such as for example medical facility 2, laboratory 10, pharmacy 8, as well as medical facility 6. The processor of the server 150 may include the medical information (e.g., laboratory results), retrieved from medical facility 2, laboratory 10, pharmacy 8, and/or medical facility 6, in a template(s) (e.g., an electronic page layout) which may be displayed in a single view of one or more displays along with other medical information associated with the one or more patients. In this regard, a template previously containing data associated with one or more medical patients may be updated to include new medical data associated with one or more patients. Additionally, or alternatively, the processor of the server 150 may receive or retrieve the medical information (e.g., laboratory results, prescription data), from medical facility 2, laboratory 10, pharmacy 8, and/or medical facility 6, and may utilize this medical information to populate the template(s) of the page layout that may be shown via a single view of one or more displays. For instance, in response to a patient(s) being newly admitted to a medical institution (e.g., hospital) there may not be any template previously set up by the processor of the server 150 that contains medical data associated with the patient(s). As such, the processor of the server 150 may utilize the medical data received from the medical facility 2, laboratory 10, pharmacy 8 and medical facility 6 to generate an initial version of a template of a page layout that may be displayed on a view of one or more displays containing relevant medical information associated with the patient(s). In this regard, in response to the processor of the server 150 receiving new medical information associated with a patient(s) from the medical facility 2, laboratory 10, pharmacy 8, and/or medical facility 6 this newly received information may be incorporated into the template or page layout so that it may be viewed and is accessible by medical care personnel.

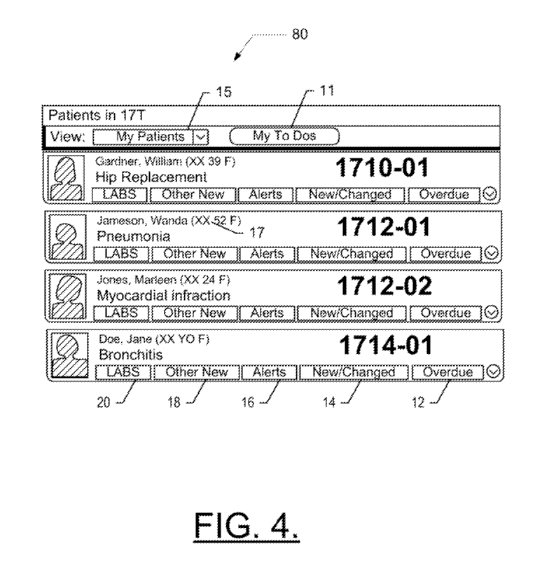

Referring now to FIG. 4, FIG. 4 illustrates medical information associated with one or more patients in a medical unit of a medical institution that is provided to a display (e.g., display 80) by the processor of the server 150. The display may show a page layout of the medical information associated with the patients. Each of the patients William Gardener, Wanda Jameson, Marleen Jones and Jane Doe are fictitious persons for purposes of illustration. Additionally, each of the four patients may be associated with a unique ID. For instance, patient William Gardner may be associated with a unique ID of “12 77 33 G”, patient Wanda Jameson may be associated with a unique ID such as “33 77 12 C”, patient Marleen Jones may be associated with a unique ID such as “10 12 24 A” and patient Jane Doe may be associated with a unique ID such as “24 03 10 J”. Additionally, the display may show the location of these patients in the medical institution. For instance, the display may show that the patients are located on the 17^{th} floor (also referred to herein as “17T”) of the medical unit and may include data specifying a room that each of the patients may be located or assigned to stay in. For instance, patient William Gardner may be located in room 1710-01, patient Wanda Jameson may be located in room 1712-01, patient Marleen Jones may be located in a room 1712-02, and patient Jane Doe may be located in a room 1714-01.

As shown in FIG. 4, a medical condition associated with each patient may be indicated by the display. In the example of FIG. 4, patient William Gardner may be scheduled to receive surgery associated with a hip replacement, patient Wanda Jameson may be diagnosed with pneumonia, patient Marleen Jones may be diagnosed as experiencing a myocardial infarction and patient Jane Doe may be experiencing bronchitis. It should be pointed out that a user such as medical care personnel (e.g., a nurse, clinical or other health care professional) may utilize a pointing device (e.g., mouse) or the like of the user input interface (e.g., user input interface 82) to select a drop down or pull-down menu 11 in order to view patients that are assigned to the medical care personnel as opposed to all of the patient within a medical facility or all of the patients on a floor (e.g., 17^{th} floor) of a medical unit (e.g., intensive care unit).

Additionally or alternatively, a drop down menu (not shown) may allow a user the option to select a list of patients in order to view corresponding medical information based on at least any one of the following; department, room/bed, care provider, work shift, location, temporary location, assigned medical personnel, unassigned to medical personnel, active orders, patient name, account number, medical record number, clinical results, or any other suitable information.

Additionally, a user such as for example medical care personnel may utilize a pointing device or the like of the input user interface to access one or more tabs which when selected provide medical data associated with one or more “labs”, “new data” (also referred to herein as “other new”), “alerts”, “new/changed” medical information as well as “overdue” medical information. For instance, selection of the “Overdue” tab 12 may present the user with a list of all overdue tasks or orders and selection of the “Other New” tab 18 may present the user with a list of all new medical diagnoses provided by a health care professional such as for example a physician. It should be pointed out that orders may include data indicating the entity from which the order was received by the processor of the server 150 and this information (not shown) may also be displayed on a display such as display 80. Additionally, the processor of the server 150 may determine that tasks or orders are overdue in response to determining that a time associated with the performing the task has expired.

Additionally, selection of the “My Patients” pull-down menu 11 may allow a user to switch to a list of all patients and selection of the “My To Dos” tab 15 may present the user with a task list associated with one or more medical tasks that need to be performed for a patient(s). Moreover, selection of the “Labs” tab 20 may allow the user to see one or more lab results associated with a patient(s) and selection of the “Alerts” tab 16 may allow a user to see one or more alerts associated with a patient. The lab results may be received from the laboratory 10. The “New/Changed” tab 14 may allow a user to see a list of new and changed orders that may be generated by a health care professional such as for example a physician, a pharmacist or any other suitable health care professional.

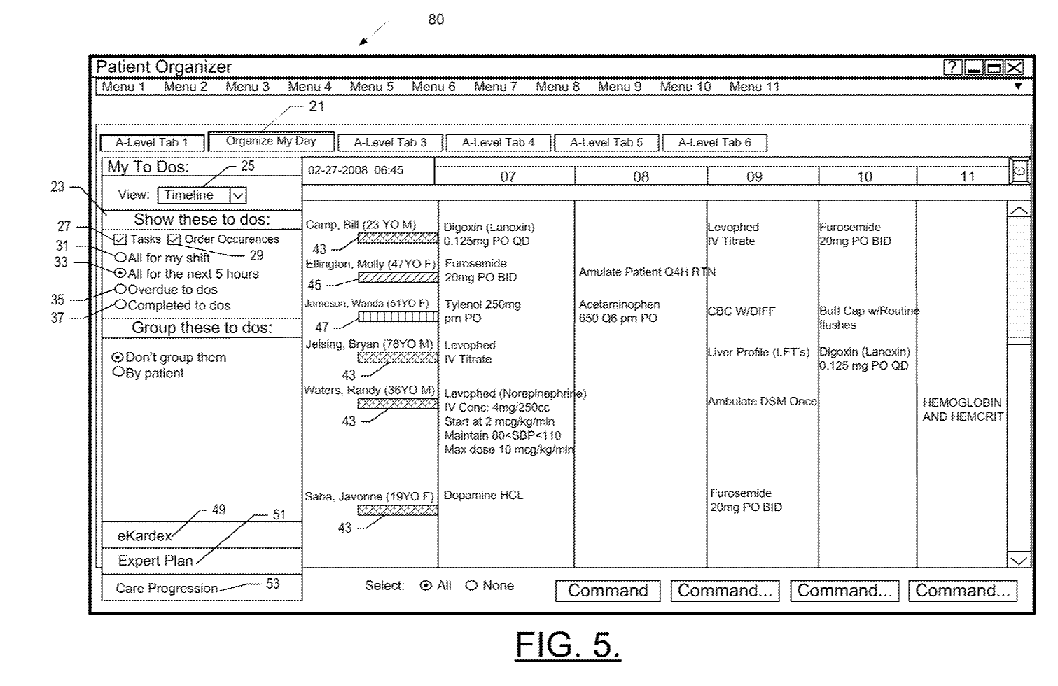

Referring now to FIG. 5, a view of a healthcare professional's assigned patients is shown and one or more action items that the health care professional is scheduled to perform at specified times for one or more patients is provided with respect to a timeline. This information may be shown in a single view of a display such as for example display 80. It should be pointed out that user may be required to login to the system 9 in order to be granted access to utilize the organize my day algorithm 87. In this regard, once the user is logged into the system the user (e.g., a health care professional, such as for e.g., a nurse) may utilize a pointing device such as for example a mouse of the user input interface (user input interface 82) to select an organize my day tab 21, which may cause the processor of the server 150 to execute the organize my day algorithm 87 which may display one or more patients assigned to the health care professional. As shown in FIG. 5, six patients are assigned to a health care professional (e.g., nurse). These patients consist of Bill Camp, Molly Ellington, Wanda Jameson, Bryan Jelsing, Randy Waters and Javonne Saba. It should be pointed out that patients Bill Camp, Molly Ellington, Wanda Jameson, Bryan Jelsing, Randy Waters and Javonne Saba relate to fictitious persons for purposes of illustration.

The display may show the date and time that the organize my day algorithm 87 is being accessed, in this example on Feb. 27, 2008 at 6:45 AM. Additionally, the display may provide a list of action items or tasks that the health care professional is scheduled to perform in a menu referred to herein for example as “My To Dos” menu 23. Moreover, the user may utilize a pointing device (e.g., mouse of the user input interface) to access a pull down menu 25 and may select an option to provide a timeline that may be generated by the processor of the server 150 upon selecting the timeline option.

The user may also utilize a pointing device to select a task button 27 as well as an order occurrences button 29 and may select a button 31 specifying that all of the tasks and orders associated with the user's assigned patients are shown for a given a shift of the user, and/or a button 33 specifying that all of the tasks and orders over the next 5 hours are shown. Additionally, the user may utilize the pointing device to select a button 35 associated with overdue tasks and/or occurrences (also referred to herein as overdue to dos) related to assigned patients as well as a button 37 associated with completed tasks and/or occurrences (also referred to herein as completed to dos) related to assigned patients. In the exemplary embodiment of FIG. 5, the user has selected the button 33 to display all tasks and/or occurrences assigned to the user for the next 5 hours. In other words, the view may be filtered so that both tasks and order occurrences may be displayed for the next 5 hours. It should be pointed out that the display may also be filtered so that medical information of a patient may be displayed based in part on a user, a user's role or a user group. The processor of the server 150 may retrieve data stored in a memory of the server and the processor of the server may display one or more tasks and/or orders corresponding to each of the assigned patients over the next 5 hours in this example for the hours between 7:00 AM and 11:00 AM. In a manner analogous to that described above, the data associated with the tasks and/or occurrences may be received by the processor of the server 150 from one or more disparate medical entities or systems (e.g., medical facility 2, laboratory 10, pharmacy 8, medical facility 6) and the processor of the server 150 may determine that this information associated with the tasks and/or occurrences is associated with a patient(s) based on a unique ID assigned to the patient which may also be contained in the data received by the disparate medical entities or systems.

As an example of a task and order consider that the processor of the server 150 determined that an order was received for the health care professional to administer 20 mg of Furosemide to patient Molly Ellington at 7:00 AM. Additionally, it should be pointed out that the red bar 45 associated with patient Molly Ellington may signify that the health care professional needs to provide medical care to patient Molly Ellington first. In this regard, the red bar 45 may indicate a critical alert to the health care professional. One or more alerts may be received by the processor of the server 150 from various medical entities or systems such as for example the medical facility 2, laboratory 10, pharmacy 8 and medical facility 6. These alerts may be associated with distinctive visible indicia, such as colors (e.g., depicted by the cross-hatching in the bars 43, 45 and 47 in FIG. 5), indicative of the relative priority with which the patient is to be treated or otherwise providing information regarding the status of the patient or the treatment of the patient. These configured alerts may be based on numerous factors and may indicate that a patient's health is deteriorating or may indicate that a change in a medical condition has occurred warranting treatment.

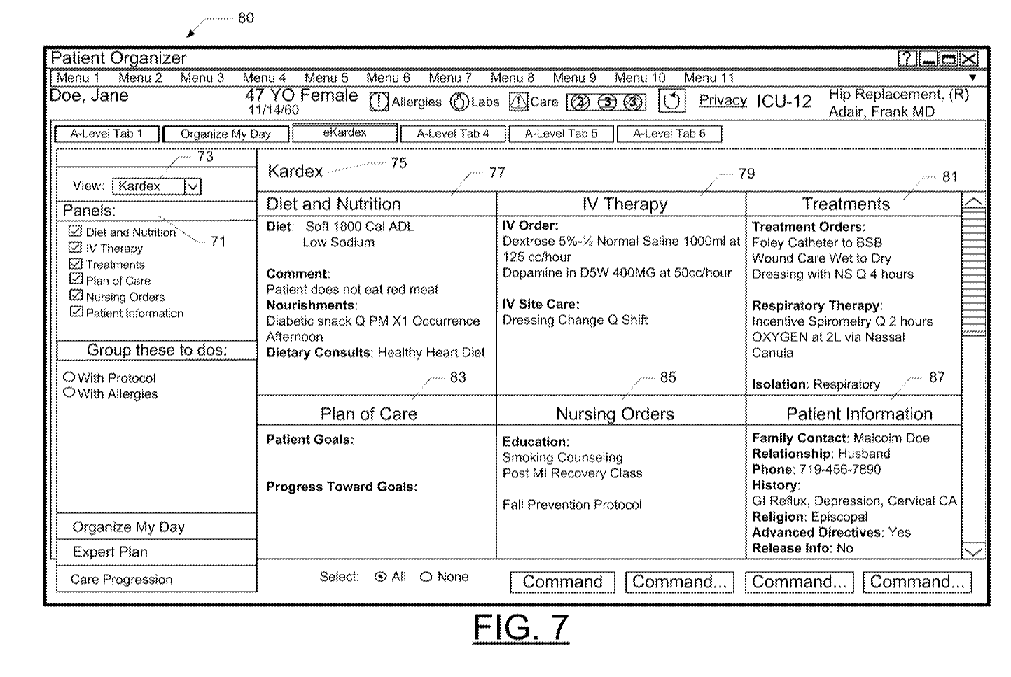

A yellow bar 43 associated with patients Bill Camp, Bryan Jelsing, Randy Waters and Javonne Saba may indicate a cautionary alert and may signify that there is something for a health care professional to take note regarding the patient but the yellow bar signifies that an action item associated with a patient(s) is not life-threatening. For example, the yellow bar may be utilized to signify that there is a new unviewed lab result but that the lab result is within normal limits and the health care professional simply needs to look at it and mark it as viewed. A green bar 47, such as for example green bar 47 associated with patient Wanda Jameson may indicate a non-critical alert and may signify that a patient(s) medical condition is stable and progressing according to plan. It should be pointed out that colors other than green, yellow and red may be used for the bars 43, 45 and 47 without departing from the spirit and scope of the invention. Additionally, a link to an electronic Kardex system 49 (also referred to herein as an eKardex system) and a link to an expert plan 51 as well as a link 53 to a care progression may be provided via a display (e.g., any of the displays of electronic devices 100, 110, 120, 130 and server 150). In this regard, a pointing device (e.g., mouse) may be utilized to select the link 49 associated with the eKardex system and upon selecting the link 49, the display may show a summary of medical information associated with a patient(s). (See e.g., FIG. 7) The pointing device may also be utilized to select the link 51 associated with the expert plan, and upon selecting the link the display may show a care plan for a patient(s) generated by a health care professional such as for example a physician. In like manner, the pointing device may be utilized to select the link 53 and in response to selecting the link 53, the display may show information identifying the progression of a patient's health (e.g., also referred to herein as care progression).

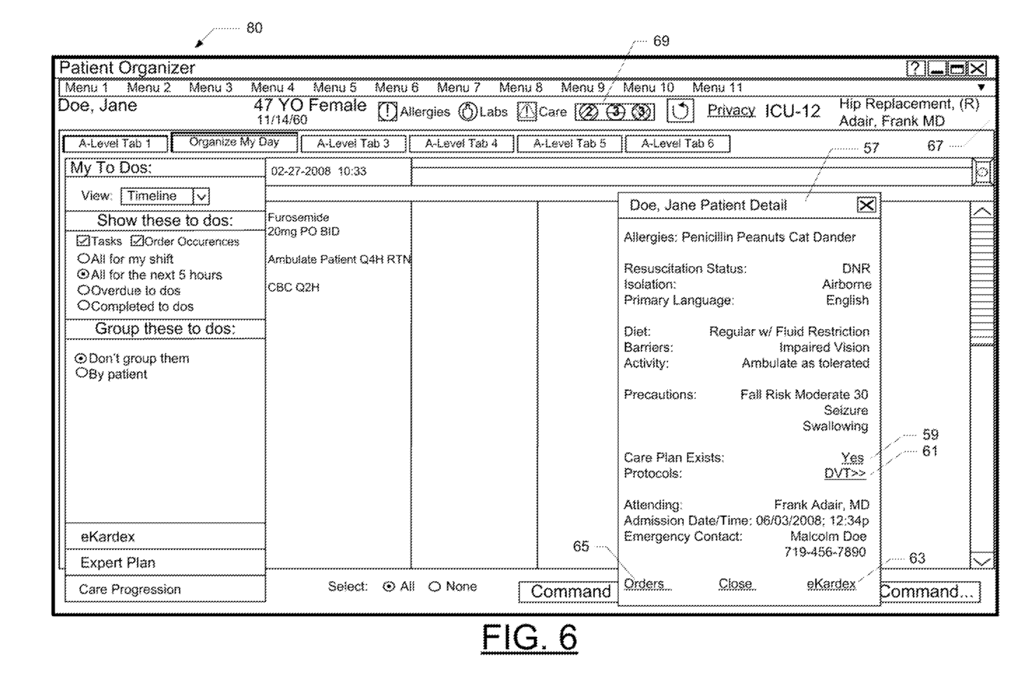

Referring to FIG. 6, FIG. 6 illustrates medical information associated with one patient in a medical unit of a medical institution that is provided to a display (e.g., display 80) by the processor of the server 150, in response to a user selecting a link 55 (e.g., hyperlink) associated with a patient(s) in the display of FIG. 5. With respect to FIGS. 5 & 6 it should be pointed out that “Q4H” denotes every 4 hours, Q2H denotes every two hours and PO BID denotes by mouth twice a day). As shown in FIG. 6, the display may show medical information associated with patient such as for example patient Molly Ellington. The medical information associated with patient Molly Ellington may be provided to the display by the processor of the server upon selection of the link 55 by a pointing device or the like.

As shown in FIG. 6, tasks and/or order occurrences are only shown for patient Molly Ellington. For instance, all of the tasks and/or order occurrences associated with patient Molly Ellington that the health care professional was scheduled to perform on Feb. 27, 2008 may be provided in a single view of the display. As shown in FIG. 5, the health care professional is scheduled to administer 20 mg. PO BID (i.e., by mouth twice a day) of Furosemide to Molly beginning at 7:00 AM, and ambulate the patient (i.e., Molly Ellington) beginning at 8:00 AM. Also, the health care professional is scheduled to perform a complete blood count (CBC), which is a medical test that gives information about blood cells for a patient, at some time during the hours of 10:00 AM and 11:00 AM. As shown in FIG. 6, each of the tasks and/or order occurrences (i.e., “Furosemide 20 mg PO BID”, “Ambulate Patient Q4H RTN”, and “CBC Q2H”) associated with patient Molly Ellington shown in the display of FIG. 5 may be shown in the display of FIG. 6 upon selecting the link 55 associated with patient Molly Ellington.

In the patient detail box 57, a user such as for example a health care professional can see comprehensive medical information about Molly and can navigate to seek more detailed information if desired. For instance, a link 59 associated with a care plan corresponding to patient Molly Ellington may be selected by a pointing device or the like and a link 61 to a protocol (e.g., a deep vein thrombosis (DVT) protocol) may be selected by utilizing the pointing device. The DVT protocol may be a protocol to prevent complications associated with DVT such as for example, complications that may occur after surgery especially after an orthopedic surgery and when patients are immobile for long periods of time. Selection of the link 59 may provide information associated with the DVT protocol to a display. Moreover, selection of the link 57 may provide information associated with a care plan for a patient, which may be generated by a physician for example.

The medical information in the patient detail box 57 may correspond to medical data that is received by the processor of the server 150 from one or more disparate medical entities or systems such as for example medical facility 2, laboratory 10, pharmacy 8, and medical facility 6, which may contain medical data associated with the patient, in this example patient Molly Ellington. Additionally, the medical information sent by the medical facility 2, laboratory 10, pharmacy 8, and medical facility 6, which may be received by the processor of the server may include a unique identifier(s) associated with the patient so that the processor of the server 150 may determine that the medical information corresponds to a particular patient in this example Molly Ellington.

A current date and time (e.g., Feb. 27, 2008 at 10:33 AM) that the medical information associated with a patient is being accessed by a user (e.g., medical personnel such as for e.g., a nurse) may be shown in the display of FIG. 6. The medical information shown in patient detail box 57 may include recorded allergies corresponding to the selected patient (e.g., penicillin, peanuts, cats, dander, etc.), resuscitation status (e.g., a Do Not Resuscitate (DNR) order which may be an order generated by a doctor or physician specifying that resuscitation should not be performed on a person), isolation status (e.g., airborne), one or more physical medical barriers (e.g., impaired vision), diet (e.g., regular with fluid restriction), activity level (e.g., ambulate as tolerated), precautions (e.g., fall risk moderate 30, seizure, swallowing), a patient's admission date/time into the medical institution (e.g., Jun. 3, 2008 at 12:34 PM), emergency contact information (e.g., Malcolm Ellington, telephone number (719) 456-7890), primary language (e.g., English), attending physician (e.g., Frank Adiar, M.D.) or a patient care plan(s). It should be pointed out that the view in display 80 of FIG. 6 may be configurable by client devices such as for example electronic devices 100, 110, 120, and 130.

As described above, a health care professional can examine the information in the patient detail box 57 and see that a patient, in this example Molly Ellington, has a care plan that can be accessed upon selecting link 59 and a protocol that can be accessed upon selecting link 61. The patient banner 67 may show the patient's location in a medical unit (e.g., ICU-12) of a medical institution (e.g., hospital), patient's age, gender, birth date, privacy status, diagnosis (e.g., hip replacement), and attending physician as well as easy to navigate links associated with allergies, labs, and other alerts. It should be pointed out that data associated with the alerts may be accessed via link 69. The link 69 may contain visible indicia indicative of the alerts. The visible indicia may consist of one or more colors (e.g. depicted by the cross-hatching in FIG. 6). Additionally, a link 65 may be accessed by a pointing device or the like to select one or more orders and a link 63 (also referred to herein as an eKardex link) may be selected to access summarized medical information associated with patient Molly Ellington.

Referring now to FIG. 7, a summary of medical information associated with a patient is provided. This summarized medical information may be referred to herein as a Kardex system (or alternatively an eKardex system) and this summarized medical information may be shown in a display such as for example display 80. The summarized medical information may be provided to a display upon selection of link 63 in FIG. 6 or link 49 in FIG. 5. Additionally, summarized medical information may be shown for a patient by selecting a Kardex option from pull-down menu 73. The Kardex system 75 may show relevant medical information associated with a patient (e.g., Molly Ellington) in various sections or blocks associated with categories such as for example, Diet and Nutrition, IV Therapy, Treatments, Plan of Care, Nursing Orders and Patient Information. The blocks and data in the blocks may be configurable by client devices such as for example electronic devices 100, 110, 120 and 130.

For example, the IV Therapy block or section 79 may show data including but not limited to one or more drip orders (e.g., “Dextrose 5%-½ Normal Saline 1000 ml at 125 cc/hour” and “Dopamine in D5W 400 MG at 50 cc/hour”) (or any other suitable orders) as well as an order(s) for providing medical care associated with the IV site of insertion (e.g., “Dressing Change Q Shift”) because these tasks may be handled by the health care professional at one time. The drip orders may relate to the type of IV (e.g., the drug) and the rate of administration and the order for care of IV site insertion may relate to care that must be done to the site where a catheter enters a patient since this site may need to be cleaned, flushed, etc. on a regular basis. The Diet and Nutrition block or section 77 may show data indicating diet orders and recommended care that the health care professional should provide to the patient. The Plan of Care block or section 83 may show patient goals and progress towards those goals. Also, the Nursing Orders block or section 85 may show one or more orders associated with one or more tasks that the nurse is to perform for the patient. The Treatment block or section 81 may show one or more treatment orders and respiratory therapy associated with patient Molly Ellington. The Patient Information block or section 87 may show demographic data associated with a patient (e.g., Molly Ellington) including but not limited to family contact, relationship, phone number, medical history, religious affiliation, advanced directives and release information (e.g., patient discharge data). Selection of one or more filters in the left panel 71 may determine what information is shown in the Kardex section on the display. As shown in FIG. 7, the Diet and Nutrition, IV Therapy, Treatments, Plan of Care, Nursing Orders and Patient Information filters are selected. It should be pointed out that all of the information in the Kardex system 75 may be received by the processor of the server 150 from one or more disparate medical entities or systems such as for example medical facility 2, laboratory 10, pharmacy 8 and medical facility 6. The processor of the server may determine that this information corresponds to a patient based on a unique ID (associated with a patient(s)) that is contained in the received information and may incorporate this information into a page layout that may be shown on a display (e.g., display 80). The display may be part of the electronic devices 100, 110, 120 and 130 as well as the server 150.

As described above, the organize my day algorithm 87 may consist of software code stored in a memory of the server 150 and may be executed by the processor of the server. Additionally or alternatively, it should be pointed out that in response to being executed by the processor of the server, the organize my day algorithm 87 may provide any of the information contained in FIGS. 4-7 in the form of a website that is maintained by the server 150. In this regard, any of the electronic devices 100, 110, 120 and 130 may access information generated by the processor of the server 150 via the network 140 (e.g., Internet) in response to accessing a web site or the like. In an alternative exemplary embodiment, the processor of the server 150 may periodically poll the memories of the electronic devices 100, 110, 120, and 130 maintained by the disparate medical entities such as for example medical facility 2, laboratory 10, pharmacy 8, and medical facility 6 in order to obtain or retrieve medical information associated with one or more patients. In an exemplary embodiment, the processor of the server 150 may periodically poll the memories of the electronic devices 100, 110, 120 and 130 every 30 minutes to determine if there is information available corresponding to one or more patients. However, it should be pointed out that the processor of the server may periodically poll the memories of the electronic devices 100, 110, 120 and 130 according to any other suitable time periods (e.g., time periods other than every 30 minutes).

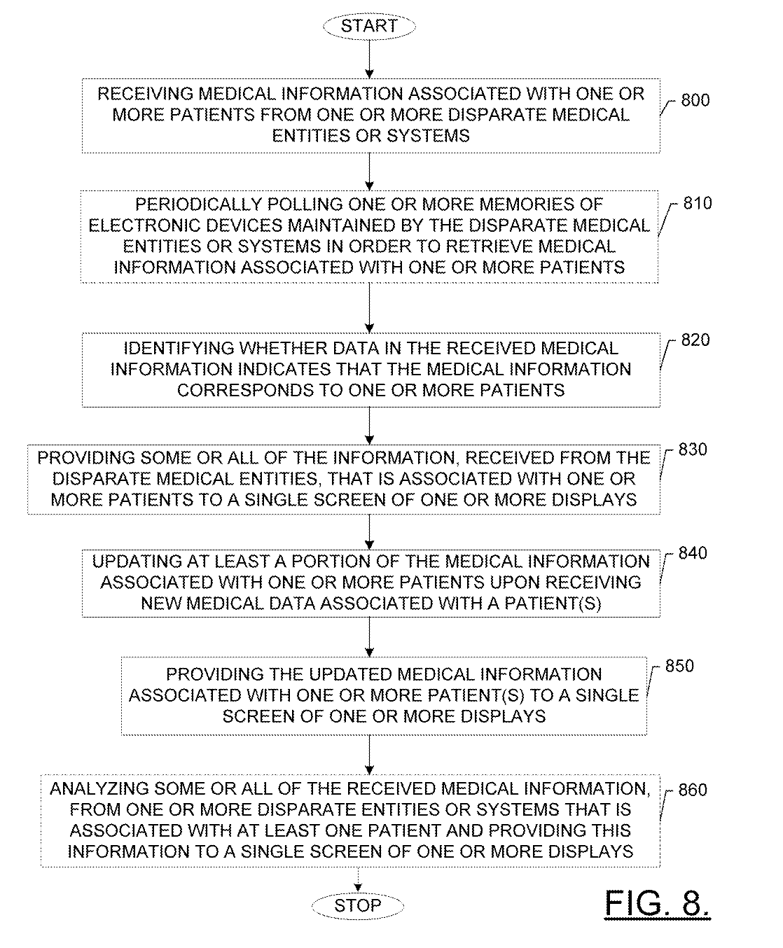

Referring now to FIG. 8, a flowchart for organizing patient data in a single view of one or more displays is provided. At operation 800, a device such as for example a processor of a server (e.g., server 150) may receive medical information associated with one or more patients from one or more disparate medical entities or medical systems (also referred to herein as different computer systems). The disparate medical entities or systems may consist of the medical facility 2, laboratory 10, pharmacy 8, and medical facility 6. Optionally, at operation 810, a device such as a processor of a server may periodically poll one or more memories of the electronic devices maintained by disparate medical entities (e.g., medical facility 2, laboratory 10, pharmacy 8, and medical facility 6) in order to retrieve medical information associated with one or more patients. At operation 820, the processor of the server may examine the received medical information sent from the disparate medical entities or systems and identify whether data in the medical information corresponds to one or more patients. The data used to identify one or more patients may correspond to a unique identifier. At operation 830, the processor of the server may provide some or all of the information, which is associated with one or more patients, received from one or more disparate medical entities or medical systems to a single view of one or more displays. The disparate medical entities or medical systems may include, but are not limited to, medical facility 2, laboratory 10, pharmacy 8, as well as medical facility 6.

At operation 840, the processor of the server may update at least a portion of medical information associated with one or more patients upon receiving new medical data associated with one or patients from one or more of the disparate medical entities or medical systems. It should be pointed out that the processor of the server may determine that the newly received medical information corresponds to a patient(s) based on a unique ID associated with the patient that is contained in the newly received information. In an alternative exemplary embodiment, upon receiving the new medical information, the processor of the server may automatically update at least a portion of medical information associated with one or more patients. Additionally or alternatively, the processor of the server 150 may retrieve new medical data associated with one or more patients by polling the memories of the electronic devices 100, 110, 120 and 130 maintained by disparate medical entities, such as for example medical facility 2, laboratory 10, pharmacy 8, and medical facility 6, in a manner analogous to that discussed above. At operation 850, the processor of the server 150 may provide the updated or new medical data associated with one or more patients to a single view of one or more displays.

Optionally, at operation 860, the processor of the server 150 may analyze some or all of the medical information associated with at least one patient (e.g., patient Molly Ellington), that is received or retrieved from one or more of the disparate medical entities or medical systems (e.g., medical facility 2, laboratory 10, pharmacy 8, or medical facility 6) and provide the medical information associated with this patient(s) to a single view of one or more displays.

It should be understood that each block or step of the flowchart shown in FIG. 8 and combination of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory of the electronic devices as well as the server and executed by a processor in the electronic device and/or the network entities, e.g., server. As will be appreciated, any such computer program instructions may be loaded onto a computer or other programmable apparatus (i.e., hardware) to produce a machine, such that the instructions which execute on the computer or other programmable apparatus (e.g., hardware) means for implementing the functions implemented specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the functions specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions that are carried out in the system.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

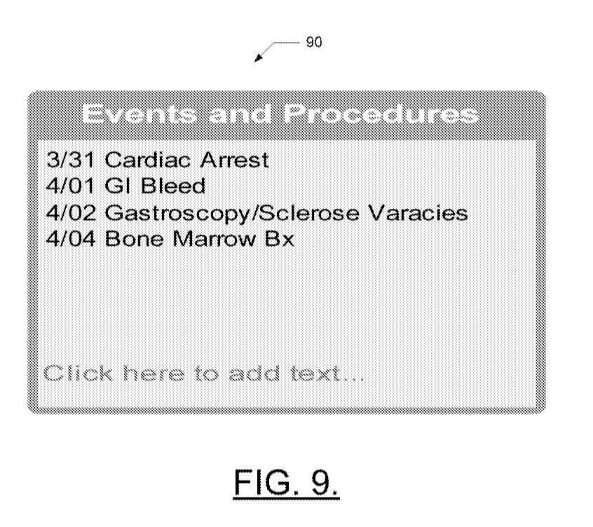

Referring now to FIG. 9 an exemplary embodiment of a Kardex panel configured to allow free-text entry is provided. The Kardex panel 90 that is configured to allow free-text entry may be generated by the processor of the server 150 in response to execution of the organize my day algorithm 87 and may be shown on a display (e.g., display 80). A user such as a clinician may utilize the user input interface (e.g., user input interface 82) of a device (e.g., electrical devices 100, 110, 120, 130 and/or server 150) to add new text, append to, or edit existing text. This text may only be displayed in association with the Kardex for the length of the patient's stay. In this regard, it is not committed permanently to the patient's record. Oftentimes, events and procedures are embedded in the narrative or dictation of a patient's chart where they cannot be accessed in a timely manner.

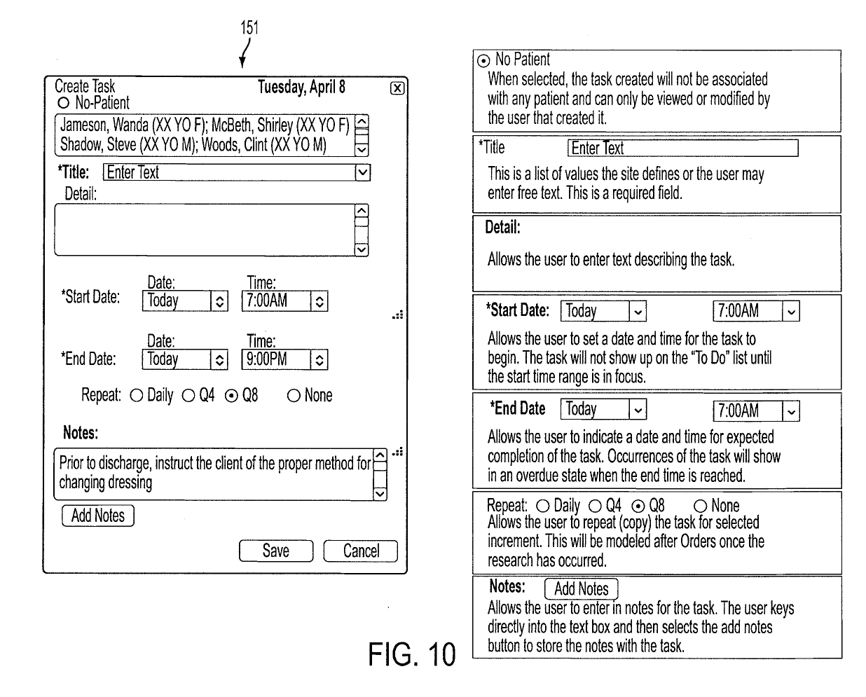

Referring now to FIG. 10, an exemplary embodiment, of a task creation and management view is provided. The task creation and management view 151 may be generated by the processor of the server 150 in response to execution of the organize my day algorithm 87 and may be shown on a display (e.g., display 80). A user, such as for example, a clinician can create one or more patient-specific or personal tasks, either in free-text or from a defined list by utilizing a user-input interface (e.g., user input interface 82) of a device (e.g., electrical devices 100, 110, 120, 130 and/or server 150). The tasks may include detail (description), one or more completion timeframe(s) or may be unassociated with a completion. Tasks may have a status of active, changed, overdue, to do, inactive, or completed. Additionally, the tasks can be modified, cancelled, and completed.

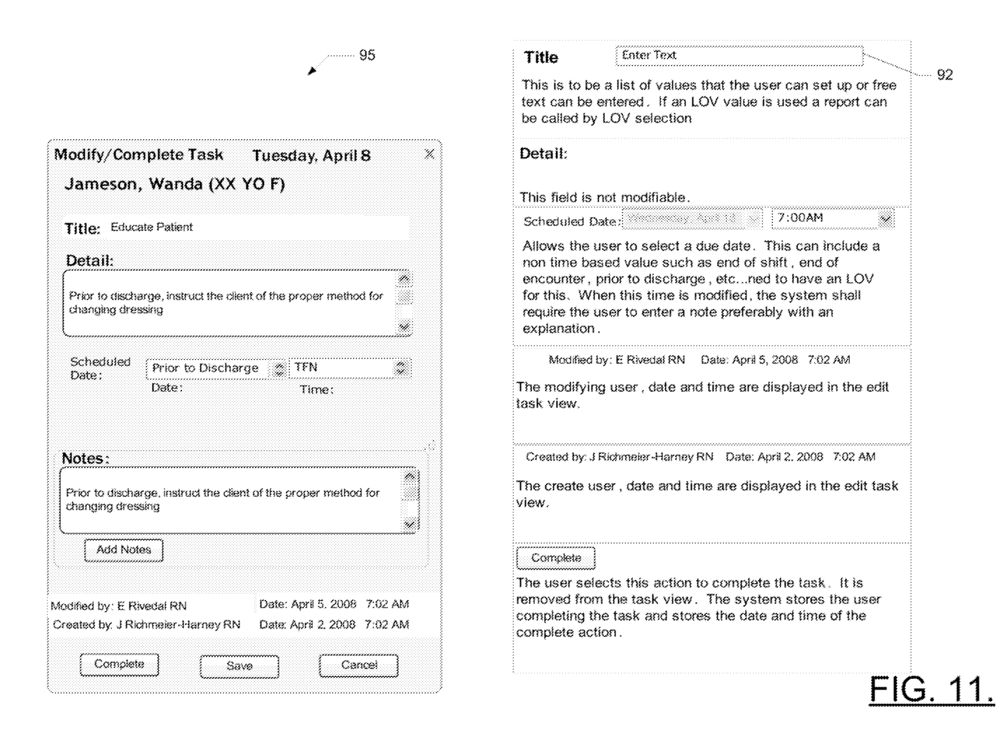

Referring to FIG. 11, an exemplary embodiment of a modify and complete task (also referred to herein as “Modify/Complete Task”) view including field narratives is provided. The modify and complete task view 95 may be displayed on a display (e.g., display 80) and the modify and complete task screen may be generated by the processor of the server 150 in response to execution of the organize my day algorithm 87. A user, such as for example, a clinician may utilize a user input interface (user input interface 82) of a device (electronic devices 100, 110, 120, 130 and/or server 150) to select a field(s) to make modifications regarding a patient(s) (e.g., patient Wanda Jameson). For instance, the user may modify a title associated with the patient. The title may be changed by entering free text into the title field or by selecting a list of values set up by the user. Additionally, the user may modify the schedule date and time. Additionally, the user may utilize the user input interface to modify a scheduled date and time. For instance, the scheduled date may be a due date, or a non time based value such as an end of shift, end of encounter, prior to discharge, etc. In response to the time being modified the processor of the server may require the user to enter a note with an explanation.

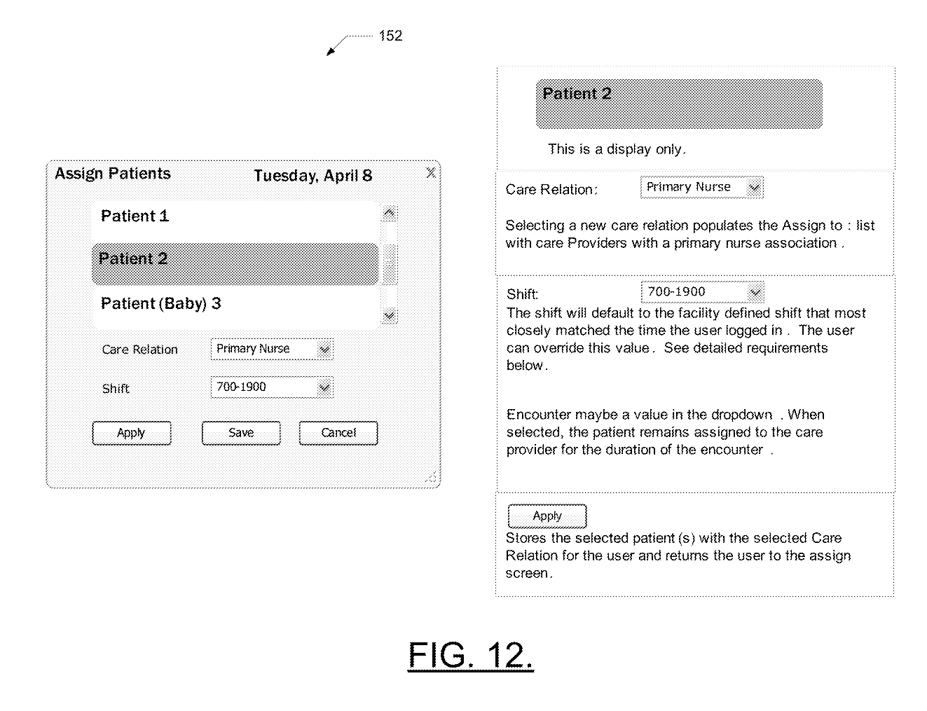

Referring now to FIG. 12, a patient self-assignment view, which may include a mother and baby (or babies) assignments is provided. A user such as for example a clinician may utilize a user-input interface (e.g., user input interface 82) of a device (e.g., electronic devices 100, 110, 120, 130 and/or server 150) to assign one or more patients to themselves in a specific role for a specific length of time. The patient self-assignment view 152 which may include mother and baby assignments, may be generated by the processor of the server 150 upon execution of the organize my day algorithm 87. Additionally, the user may optionally view a mother together with her related baby (or babies) when she has responsibility for care of both the mother and her baby. Babies may be individually deselected from the assignment in cases where the baby is in neonatal intensive care unit (ICU) or being relinquished. Care relations are site-defined and the length of time the provider assignment applies is a shift. The user may ‘end’ the care relation assignment documenting the reason for ending the assignment.

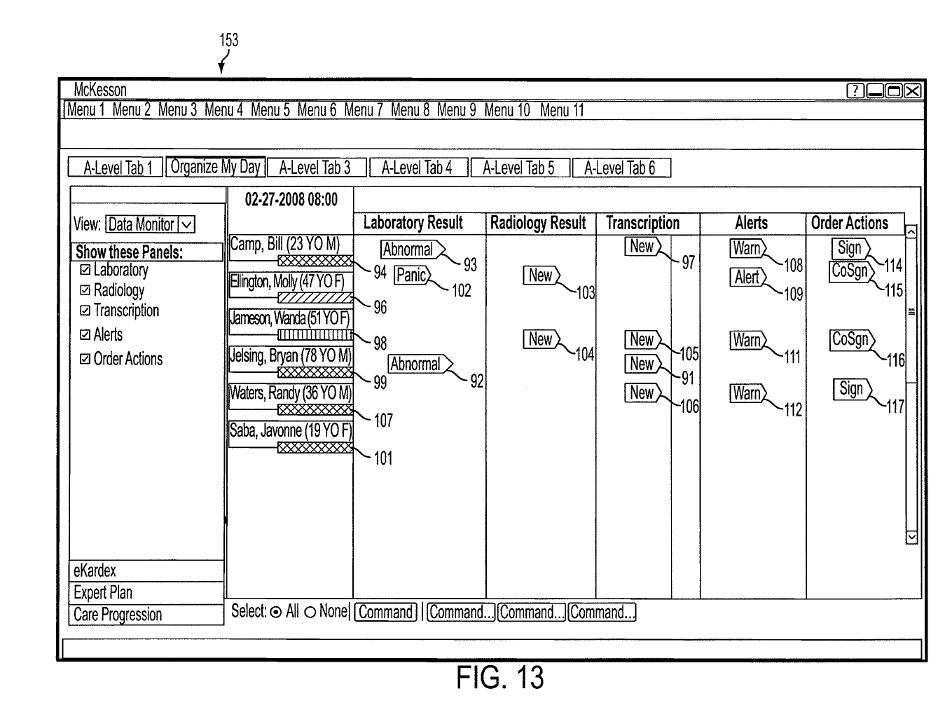

Referring now to FIG. 13, an exemplary embodiment of a patient data monitor view that is configurable to show one or more patients is provided. The patient data monitor view 153 may be generated in response to the processor of the server executing the organize my day algorithm 87. The patient data monitor view provides a visual display of bars such as the red bar 96, yellow bars 94, 99, 101, 107 or green bars 98 in the corresponding patient blocks. It should be pointed out that the colors of the bars may be depicted by the cross-hatchings of the bars shown in FIG. 13. Additionally, the patient data monitor view shows alerts 108, 109, 111 and 112, as well as order actions 114, 115, 116 and 117. Selecting a bar(s), also referred to herein as an icon(s), (e.g., bars 94, 96, 98, 99, 101, or 107) may take the user to an associated module(s) where the user may review or take action regarding the bar. For instance, selection of yellow bar 94 may take the user to the abnormal lab result 93 which also contains visible indicia (e.g., a yellow color) indicating that the yellow bar 94 was generated based on (or in response) to the abnormal lab result 93 corresponding to patient Bill Camp. In this regard, the yellow bar 93 and the abnormal lab result 93 are associated with each other. As another example, selection of red bar 96 may take the user to the critical lab result 102 (also referred to herein as panic lab result) which also contains visible indicia (e.g., a red color) indicating that the red bar 96 was generated based on (or in response) to the critical lab result 102 corresponding to patient Molly Ellington. It should be pointed out that the patient data monitor view may show new radiology results 103 and 104 associated with patient Molly Ellington and Bryan Jelsing respectively. Additionally, the patient monitor view may show new transcripts 105 and 106 associated with patients Bryan Jelsing and Javonne Saba, respectively.

The patient data monitor view may enable a user (e.g., clinician) to decide on the priority of action for each item when combined with information from other sources such as observations (e.g., physical assessments) or planned activities (e.g., surgeries). For example, the abnormal lab result 93, which contains visible indicia (e.g., a color yellow), for patient Bill Camp may have priority over the arrival of a new transcription 97 because the clinician is waiting for the results of a blood culture obtained on the last shift as a possible explanation for his elevated temperature 2 days post-op. However, patient Randy Waters may have a new transcription 91 which turns out to be of equal importance with the abnormal lab result 92 because the user (e.g., clinician) is preparing patient Randy Waters (and his chart) for surgery at a particular time (e.g., in an hour), and as such the user may be scrambling to gather the most recent lab results and the physician-dictated History and Physical (H&P) information so the user can provide a verbal report to pre-op staff. One or more yellow warning icons (e.g., alerts 108, 111, and/or 112) and red alert icons (e.g., alert 109) may appear in the Alerts column when a set of pre-defined criteria (one or more data points) is outside that which is expected. For example, a yellow alert (e.g., alerts 108, 111 or 112) may indicate that it is time for a re-evaluation of the patient's care plan to remain compliant with a hospital's defined policy. The red alert 109 may indicate that the sum of data points is worthy of further action. For example, a decrease in a patient's charted urine output (from a charting application), together with an elevation in blood urea nitrogen (BUN) and an elevation in creatinine level (from the lab system) may indicate decreased kidney function which is worthy of further evaluation and action. One or more green sign icons (e.g., icons 114 and 117) and blue cosgn icons (e.g., 115 and 116) may appear in the Order Actions column when one or more orders exist that need to be signed off by the physician. For example, verbal or phone orders from physicians must be signed off within a pre-defined period of time to remain compliant with hospital policy. In teaching hospitals a physician must cosign the orders written by a resident intern.

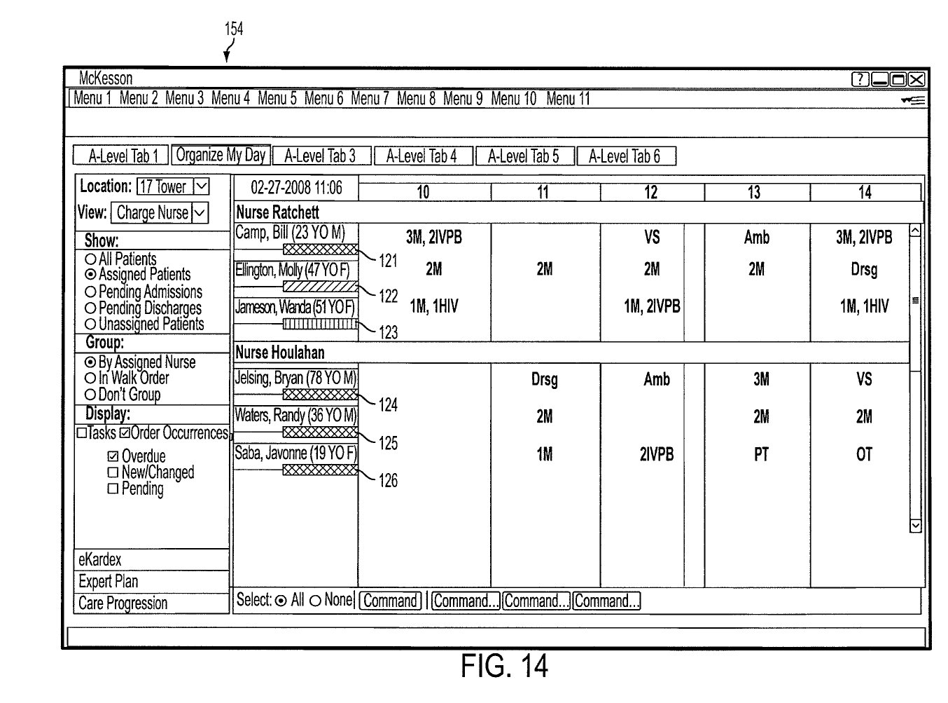

Referring now to FIG. 14, a charge nurse view according to an exemplary embodiment is provided. The charge nurse view 154 may be generated in response to the processor of the server executing the organize my day algorithm 87 and the charge nurse view may be shown on a display (e.g., display 80). The charge nurse view may contain one or more bars 121, 122, 123, 124, 125 and 126 and each bar may be indicative of alert associated with a particular patient. Each of the bars may contain visible indicia (e.g., color), depicted by the cross-hatching in each bar, which may indicate the health of a corresponding patient. For instance, the bars 121, 124, 125 and 126 may contain visible indicia such as for example a color, in this example yellow, which may indicate that the health of a respective patient (e.g., patient Bill Camp corresponding to bar 121) is in a cautionary state. Moreover, bar 122 may contain visible indicia, such as for example a color, in this example green, which may indicate that the health of a respective patient (e.g., patient Wanda Jameson) is in a healthy state. Also, bar 121 may contain visible indicia, such as for example a color, in this example red, which may indicate that the health of a respective patient (e.g., Molly Ellington) is in critical condition.

The charge nurse view may be tailored for the nurse in charge of a unit for a shift. The charge nurse view may provide a visual status of each direct care clinician's (e.g., nurse) workload as well as one or more upcoming tasks. Patients that have overdue, pending or new/changed orders that need attention are easily discernable from the charge nurse view. In this regard, the charge nurse view is a high level view that informs the charge nurse where help is needed. In the exemplary embodiment of FIG. 14, the charge nurse may view the order occurrences (including overdues) for patients assigned to Nurse Ratchett and Nurse Houlahan. The current time is 11:06 AM and Nurse Ratchett has not completed her 10:00 AM order occurrences. In contrast, Nurse Houlahan has completed her 10:00 AM order occurrences. The charge nurse view provides a visual representation of what needs to be done to help a clinician (e.g., Nurse Ratchett) catch up on their workload.

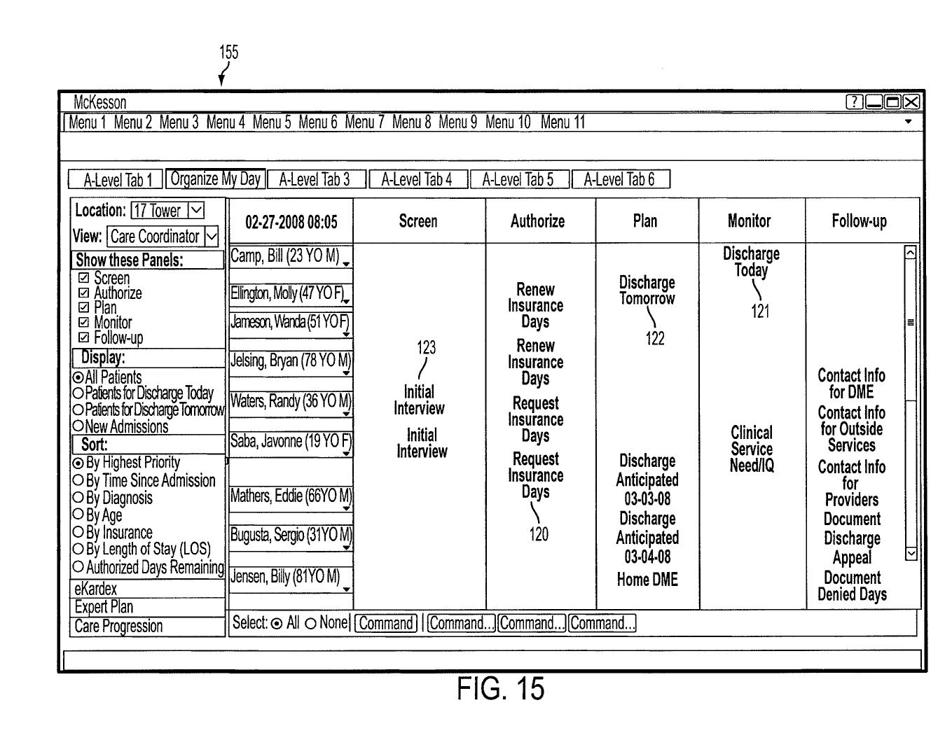

Referring now to FIG. 15, an exemplary embodiment of a care coordinator view is provided. The care coordinator view 155 (also referred to herein as care coordinator/therapist/nutritionist view) may be generated in response to the processor of the server 150 executing the organize my day algorithm 87. Additionally, the care coordinator view may be shown on a display such as for example display 80. The care coordinator view may be tailored for one or more users, such as for example, a discharge planner, a utilization reviewer, a therapist, nutritionist, etc. The roles and services provided by the user(s) may be best managed by a patient/task matrix that is generated by the processor of the server 150, in which one or more tasks may have a weight assigned to them by the processor of the server 150. The weights assigned to the tasks may define their priority among all tasks to be accomplished for all patients on a specific day (e.g., Feb. 27, 2008). Task groups may be defined (by a medical facility) and given a weight of importance in the day's workload. The Discharge Task Group may have a weight of 10 because that group's tasks have the most importance in a day's workload. Individual tasks may be defined within task groups and given a priority within the group. For instance, Discharge Today is a task in the Discharge Task Group with a priority of 1—discharging patients on time prevents revenue penalties and makes the bed available for a new admission. Discharge Tomorrow is a task in the Discharge Task Group with a priority of 2—evaluating discharge readiness the day prior to a planned discharge allows for corrective action if necessary. The Admission Task Group has a weight of 9 because that group's tasks are second in importance to the Discharge Task Group. The Initial Interview, Request Insurance Days, and Renew Insurance Days are all tasks in the Admission Task Group. Initial Interview may have a priority of 1—it is important to identify patient or family needs early that might alter the insurance days authorized. Request Insurance Days and Renew Insurance Days may have a priority of 2—these are essentially the same thing except one is an initial request and the other is an additional request—both keep the patient's progression in alignment with the insurance days being reimbursed which prevents lost revenue. Based on the task group weight and task priority descriptions above, Bill Camp has a priority 1 task which occurs within the Discharge Task Group weighing 10 so he moves to the top of the display. Molly Ellington has a priority 2 task within the Discharge Task Group and thus appears on the task/patient matrix in second position. Wanda Jameson and Bryan Jelsing both have a Renew Insurance Days task with a priority of 2 from the Admission Task Group whose weight is 9 which is why they are displayed in alpha last name descending as the 3^{rd} and 4^{th} patients on the list. During the initial interview with Randy Waters, the care coordinator may learn that Randy has just relocated to the state and upon his discharge will need a new supplier for his oxygen. In the exemplary embodiment of FIG. 15, the care coordinator choose to add Contact Info for DME as a non-prioritized task until Randy is closer to discharge. The care coordinator can choose to select and drag a patient block (and related task row) into a higher or lower position on the list if she wishes to override the weighted default display.

For example, requesting insurance authorized days task 120 (also referred to herein as request insurance days) may be a task that shows up automatically for all patients that are newly admitted to a health care facility. On a given day(s), for example the next time insurance is due, the requesting insurance authorized days task 120 may automatically show up as a task corresponding to a given patient and may rank below the discharges due today task 121 and the discharge due tomorrow task 122. In other words, the requesting insurance authorized days task 120 may be assigned a weight (e.g., a value such as 30) that is lower that a weight (e.g., a value such as 50) of the discharge due today task 121 or the discharged due tomorrow task 122 (e.g., a value such as 70). Additionally, in an exemplary embodiment, the requesting insurance authorized days task 120 may appear before the initial interviews due today task 123 (also referred to herein as initial interview) and the requesting insurance authorized days task 120 and the initial interviews due today task 123 may be associated with the same patient (e.g., patient Randy Waters). As such, the requesting insurance authorized days task 120 may be assigned a weight (e.g., a value such as 30) by the processor of the server that is greater than a weight (e.g., a value such as 20) assigned by the processor of the server to the initial interviews due today task 123. It should be pointed out that the patient with the tasks of the highest priority in groups with the greatest weight may be displayed first in the care coordinator view.

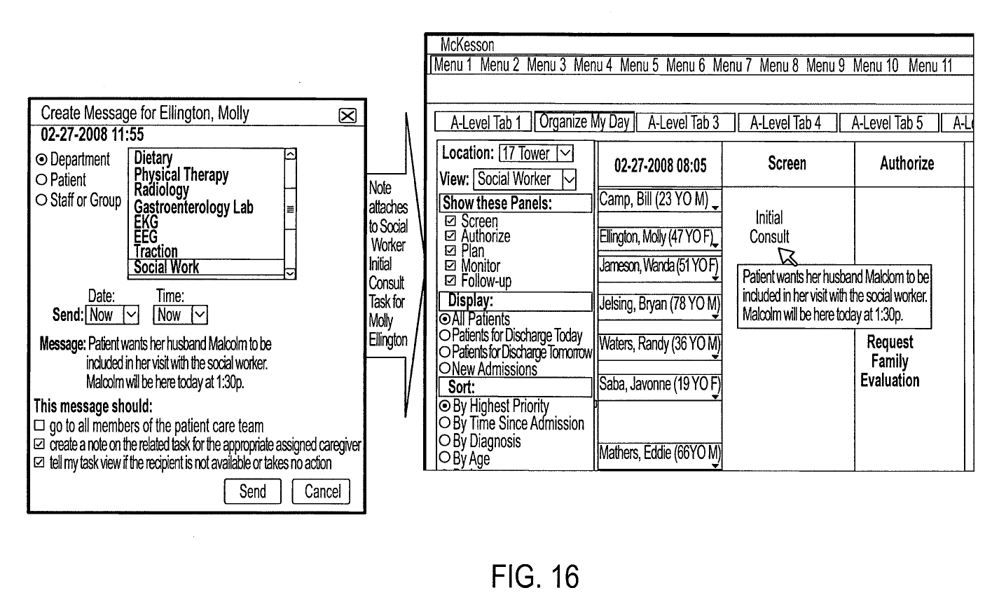

Referring now to FIG. 16, an exemplary embodiment of a smart communication view is provided. The organize my day algorithm, upon being executed by the processor the server may include the ability to create and exchange text messages with other users, groups of users and patients, adhering to the Health Insurance Portability and Accountability Act (HIPAA) mandates for patient privacy. Messages may include context data for patient, staff, staff group, staff assignments to patients or locale, allowing distribution to the users to whom they apply (e.g. direct caregivers, patient care team, or departments). Messages created and sent can generate tasks or attach notes to existing tasks which may be shown in a display (e.g., display 80) in the user's view of the organize my day (OMD) application 87. An audit trail of activities occurring on a sent message including date/time stamps, actions, and associated staff may be stored in a memory device (e.g., memory 86).

The exemplary embodiment of FIG. 16 shows that a nurse created a message for patient Molly Ellington to notify a social worker that Molly's husband wants to be present for the initial consultation. This method of communication eliminates the phone/verbal messaging chaos associated with a multidisciplinary team caring for a patient. It promotes timely message delivery directly to a specific user applied directly to a specific patient and task which is accessible when the recipient is ready to act upon it.

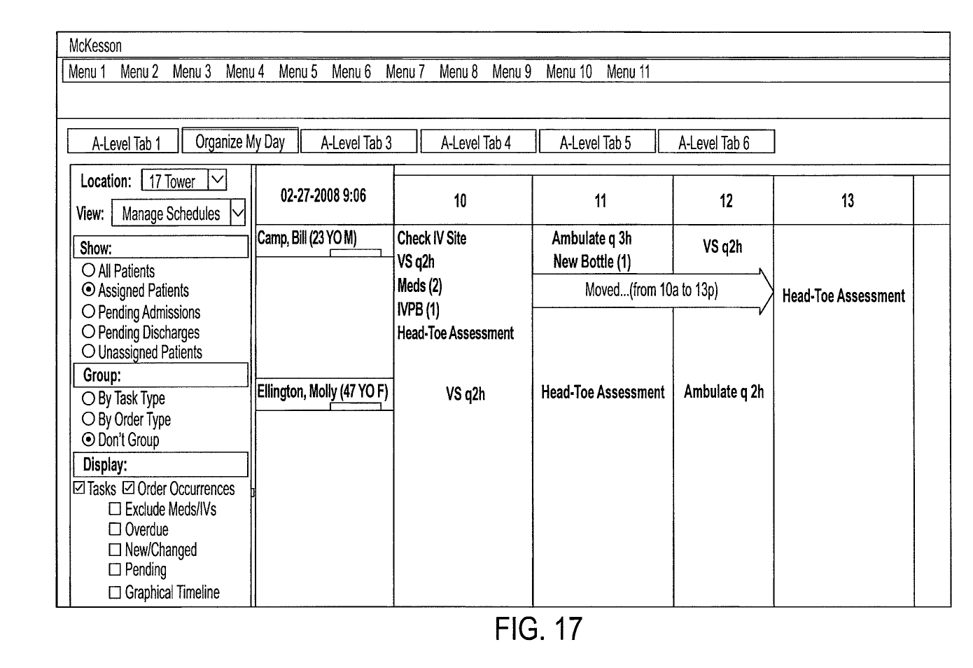

Referring now to FIG. 17, a schedule management according to an exemplary embodiment is provided. The organize my day algorithm, upon being executed by the processor of the server may allow users to manage schedules for patient events, such as orders and medications. The user can view a graphical timeline representation of the scheduled events for a day and move events on the timelines to balance the workload across the day. Security may be applied to schedules to determine which events can be moved and which events must remain at the exact time scheduled. When medications are moved to different times, a pharmacy may be notified and the change is synchronized with the pharmacy database.

In the exemplary embodiment of FIG. 17, Bill Camp has 5 schedules due at 10 AM. The nurse notes that the ‘Head-Toe Assessment’ can be done anytime as long as it is once per shift. The nurse selects and drags it to 1300 (e.g., 13) where there are no competing schedules. This balances the nurse's workload for the day and allows the nurse to stay on schedule with the medication administrations due at 10 AM since medication administrations are generally not flexible.

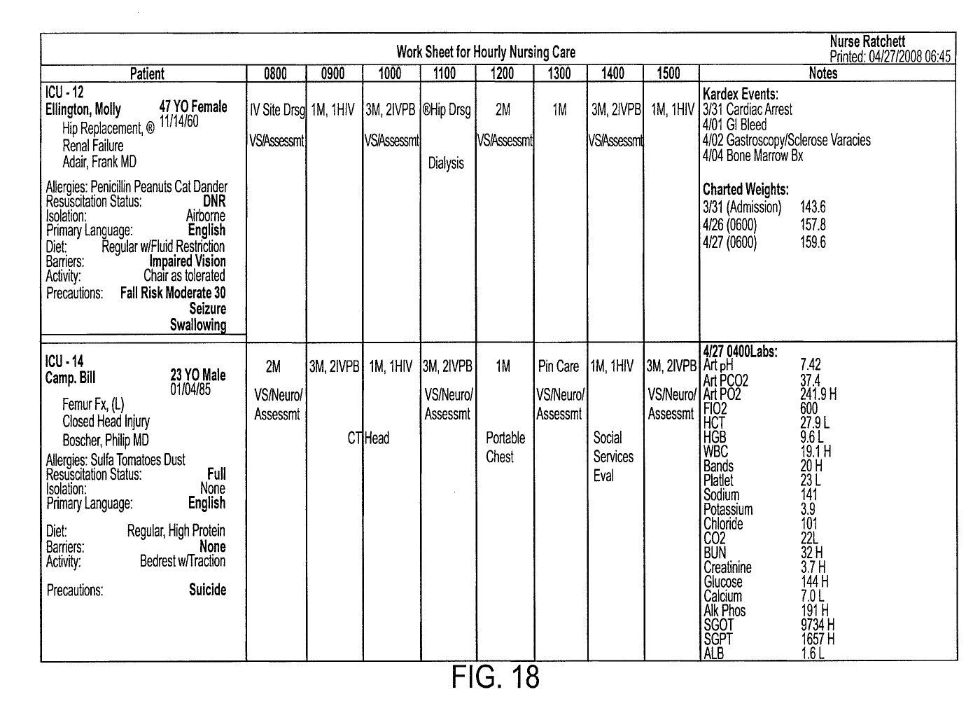

Referring now to FIG. 18, a view of a clinician's (e.g., nurse's) organizational report according to an exemplary embodiment is provided. At the beginning of a shift, clinician's (e.g., nurses) may create a piece of paper, referred to as ‘The Nurse's Brain’ which they reference throughout their shift. They draw out rows to represent assigned patients and columns corresponding to each hour of their assigned shift. Then they search and gather information from various data sources to fill in demographics, allergies, key conditions/limitations, scheduled events, and other pertinent information about their patient's condition/care. They manually update this worksheet throughout the shift so by the end of the shift it has become the tool from which they provide ‘report’ about their patients to the on-coming shift.

Automating this form, offering site configurability and populating it with data from these various sources would eliminate much of this searching and gathering activity at the beginning of the shift which oftentimes consumes an hour or more of the nurse's time—time that could be more efficiently spent performing patient care.

In the exemplary embodiment of FIG. 18, Nurse Ratchett prints the worksheet at 06:45 on Apr. 27, 2008 because she is assigned two patients in the intensive care unit (ICU). The intensive care unit has configured the form to print the patient location, patient name, age, gender, date of birth (DOB), diagnoses, and attending physician. Additionally, the patient block has been configured to include patient allergies, resuscitation status, isolation, primary language, diet, barriers to care, activity order, and precautions. Scheduled meds, IVs, tasks such as dressing changes, pin care, vital signs, neuro checks, and assessments appear in the time columns along with ordered activities such as CT Head, Portable Chest, Dialysis, and Social Services Eval for the patient. In the notes column key past events for this admission, charted weight values, and the results from this morning's lab print saving the nurse a great deal of searching and gathering effort.

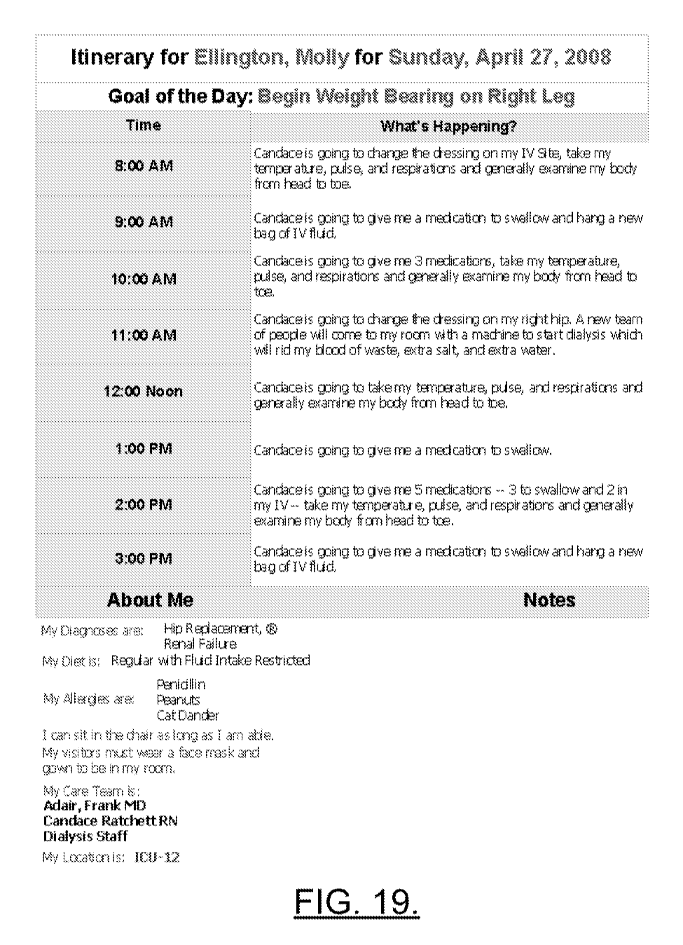

Referring now to FIG. 19, a view of a patient's itinerary report according to an exemplary embodiment is provided. Patients are often the last to know their own schedules in the hospital. The Patient Itinerary report generated by the organize my day algorithm upon being executed by the processor of the server may include all scheduled events, tasks and medications for the day and provide space to write in other events that are not available via automated scheduling systems. The report will also include a complete listing of the care providers currently assigned to the patient and optionally contact information for those marked as primary care providers. The Goal of the Day may display and optionally a listings of problems and interventions.

It should be pointed out that the patients and nurses referred to in the exemplary embodiments of FIGS. 9-19 represent fictitious patients and nurses for purposes of illustration.

As described above, the exemplary embodiments may provide health care professionals (e.g., nurses, therapists or the like) with a summary view of medical data associated with their patient(s). Additionally, the exemplary embodiments may provide a picture of patient information allowing health care professionals to prioritize care among multiple patients. In this regard, the exemplary embodiments may provide a centralized source for accessing medical information associated with one or more patients so that medical personnel may understand the appropriate level of medical care associated with one or more of their patients and see new medical information associated with one or more patients easily and timely without having to search for this information in multiple systems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
receiving medical information, associated with one or more patients, from one or more different computer systems;
storing the received medical information in a memory;
examining, via a processors the received medical information stored in the memory and identifying whether data in the received medical information indicates the medical information corresponds to one or more patients, the data comprises one or more unique identifiers (IDs) associated with the one or more patients;
providing one or more portions of the received medical information to a single view of one or more displays;
configuring the one or more portions of the received medical information to generate a summary view of the medical information received from the one or more different computer systems, the medical information is associated with at least one of the patients;
updating, via the processor, at least a first portion of the received medical information upon receiving additional medical data associated with the first portion in response to a determination indicating that the additional medical data corresponds to at least one patient, the additional medical data also being stored in the memory;
providing the first portion, as updated, to the single view of the one or more displays; and
providing at least one alert, received from at least one of the different computer systems, to the summary view, the at least one alert comprises data indicating a medical status associated with the patient.

2. The method of claim 1, wherein receiving comprises periodically polling one or more memories of one or more devices at predetermined time intervals to receive the medical information.

3. The method of claim 1, wherein the determination comprises evaluating whether the new medical data comprises at least one of the unique IDs.

4. The method of claim 1, further comprising analyzing at least a second portion of the received medical information corresponding to one of the patients and providing the second portion to the single view of the one or more displays.

5. The method of claim 1, further comprising configuring the one or more portions of the received medical information, based at least in part on any one of a user, a user's role, or a user group, to display medical information associated with at least one patient that is assigned to at least one health care professional.

6. The method of claim 1, further comprising, generating one or more alerts at a predetermined time prior to the occurrence of one or more corresponding events, the events are associated with providing medical care to the at least one patient.

7. The method of claim 1, further comprising obtaining medical information associated with the patient in response to selecting the alert.

8. The method of claim 7, wherein the data of the alert comprises visible indicia and the visible indicia is generated in response to the medical information.

9. The method of claim 8, further comprising determining a priority in which to perform one or more tasks associated with the patient on the basis of the visible indicia.

10. The method of claim 1, further comprising:
assigning a value to one or more tasks associated with a plurality of patients; and
displaying information associated with the plurality of patients in an order of priority along with the associated tasks, the order of priority is based at least in part on the value assigned to each of the tasks.

11. The method of claim 5, further comprising:
determining whether one or more tasks assigned to the health care professional is overdue; and
providing information indicating that at least one task, among the tasks, is overdue to the view of the one or more displays in response to a time associated with the task expiring.

12. The method of claim 6, wherein the one or more alerts comprise data indicating medical care that a health care professional is to provide to at least one of the patients at a specified time.

13. The method of claim 6, wherein at least one of the alerts signifies that a condition of the at least one patient is deteriorating and requires immediate medical attention by a health care professional.

14. An apparatus comprising a processor configured to:
receive medical information, associated with one or more patients, from one or more different computer systems;
store the received medical information in a memory;
examine the received medical information stored in the memory and identify whether data in the received medical information indicates the medical information corresponds to one or more patients, the data comprises one or more unique identifiers (IDs) associated with the one or more patients;
provide one or more portions of the received medical information to a single view of one or more displays;
configure the one or more portions of the received medical information to generate a summary view of the medical information received from the one or more different computer systems, the medical information is associated with at least one patient;
update at least a first portion of the received medical information upon receiving additional medical data associated with the first portion in response to a determination indicating that the additional medical data corresponds to at least one patient, the additional medical data is also being stored in the memory;
provide the first portion, as updated, to the single view of the one or more displays; and
provide at least one alert, received from at least one of the computer systems, to the summary view, the alert comprises data indicating a medical status associated with the patient.

15. The apparatus of claim 14, wherein the processor is configured to receive by periodically polling one or more memories of one or more devices at predetermined time intervals to receive the medical information.

16. The apparatus of claim 14, wherein the processor is configured to perform the determination by evaluating whether the new medical data comprises at least one of the unique IDs.

17. The apparatus of claim 14, wherein the processor is further configured to analyze at least a second portion of the received medical information corresponding to one of the patients and provide the second portion to the single view of the one or more displays.

18. The apparatus of claim 14, wherein the processor is further configured to manipulate the one or more portions of the received medical information to display medical information associated with at least one patient that based at least in part on any one of a user, a user's role, or a user group.

19. The apparatus of claim 14, wherein the processor is further configured to generate one or more alerts, comprising visible indicia, at a predetermined time prior to the occurrence of one or more corresponding events, the events are associated with providing medical care to the at least one patient.

20. The apparatus of claim 14, wherein the processor is further configured to obtain medical information associated with the patient in response to selecting the alert.

21. The apparatus of claim 20, wherein the data of the alert comprises visible indicia and the visible indicia is generated by the processor in response to receipt of the medical information.

22. The apparatus of claim 21, wherein the processor is further configured to utilize the visible indicia to identify a priority in which to perform one or more tasks associated with the patient.

23. The apparatus of claim 14, wherein the processor is further configured to:
assign a value to one or more tasks associated with a plurality of patients; and
display information associated with the plurality of patients in an order of priority along with the associated tasks, the order of priority is based at least in part on the value assigned to each of the tasks.

24. The apparatus of claim 18, wherein the processor is further configured to determine whether one or more tasks assigned to the health care professional is overdue; and
provide information indicating that at least one task, among the tasks, is overdue to the view of the one or more displays in response to a time associated with the task expiring.

25. The apparatus of claim 19, wherein the one or more alerts comprise data indicating medical care that a health care professional is to provide to the at least one patient at a specified time.

26. The apparatus of claim 19, wherein at least one of the alerts comprises visible indicia which signifies that a condition of the at least one patient is deteriorating and requires immediate medical attention by a health care professional.

27. A computer program product, the computer program product comprising at least one computer-readable storage medium having computer-readable program code portions stored therein, the computer-readable program code portions comprising:
a first executable portion configured for receiving medical information, associated with one or more patients, from one or more different computer systems
a second executable portion configured for storing the received medical information in a memory;
a third executable portion configured for examining the received medical information stored in the memory and identifying whether data in the received medical information indicates the medical information corresponds to one or more patients, the data comprises one or more unique identifiers (IDs) associated with the one or more patients;
a fourth executable portion configured for providing one or more portions of the received medical information to a single view of one or more displays;
a fifth executable portion configured for manipulating the one or more portions of the received medical information to generate a summary view of the medical information received from the one or more different computer systems, the medical information is associated with at least one patient;
a sixth executable portion configured for updating at least a first portion of the received medical information upon receiving additional medical data associated with the first portion in response to a determination indicating that the additional medical data corresponds to at least one patient, the additional medical data is also being stored in the memory;
a seventh executable portion configured for providing the first portion, as updated, to the single view of the one or more displays; and
an eighth executable portion configured for providing at least one alert, received from at least one of the different computer systems, to the summary view, the at least one alert comprises data indicating a medical status associated with the patient.

28. The computer program product of claim 27, wherein receiving comprises periodically polling one or more memories of one or more devices at predetermined time intervals to receive the medical information.
